(19) United States
(12) Patent Application Publication
(10) Pub. No.: US 2026/0227368 A1
(43) Pub. Date: Aug. 6, 2026

(54) FIELD-FLOW FRACTIONATION DEVICE

(71) Applicant: SHIMADZU CORPORATION, Kyoto-shi (JP)

(72) Inventor: Natsuko YAMAMOTO IEFUJI, Kyoto-shi (JP)

(73) Assignee: SHIMADZU CORPORATION, Kyoto-shi (JP)

(21) Appl. No.: 19/457,703

(22) Filed: Jan. 23, 2026

(30) Foreign Application Priority Data
Jan. 29, 2025 (JP) 2025-013041

(51) Int. Cl. G01N 30/00

(52) U.S. Cl. CPC G01N 30/0005; G01N 2030/003; G01N 2030/0045

(57) ABSTRACT

A field-flow fractionation device in the present disclosure classifies particles included in a sample. The field-flow fractionation device includes a flow cell, a fluid supply unit, a sample introduction unit, a laser irradiation device, and a control device. The flow cell constitutes a flow path through which particles flow. The fluid supply unit supplies a fluid to the flow path. The sample introduction unit introduces the sample into the flow path. The laser irradiation device irradiates the flow path with a plurality of laser beams. The control device controls irradiation conditions of the plurality of laser beams.

### TECHNICAL FIELD

The present disclosure relates to a field-flow fractionation device, and more specifically, to improving the recovery rate of particles in field-flow fractionation.

### BACKGROUND ART

As a classification method for separating fine particles in a solution according to their size, a field flow fractionation (FFF) method is known. The FFF method is a method for classifying multiple types of particles based on the diffusion coefficient of each fine particle in a solution without using a stationary phase in a separation layer. As a type of the FFF method, for example, as disclosed in Japanese Patent Laying-Open No. 2008-000724 (Patent Document 1), an asymmetrical flow field-flow fractionation (AF4) method, which is a cross-flow classification method adopting an asymmetrical channel structure, is known.

### Prior Art Documents

### Patent Documents

Patent Document 1: Japanese Patent Laying-Open No. 2008-000724

### SUMMARY OF THE INVENTION

### Problems to be Solved by the Invention

In the AF4 method, particles are temporarily pressed against a separation membrane in a flow cell by the flow of a solution. At this time, the particles may be adsorbed to the separation membrane, which may lower the recovery rate of the particles.

The present disclosure was made in view of such circumstances, and an object thereof is to improve the recovery rate of particles in field-flow fractionation.

### Means for Solved the Problems

A field-flow fractionation device according to one aspect of the present disclosure is a field-flow fractionation device for classifying particles included in a sample. The field-flow fractionation device includes: a flow cell constituting a flow path through which the particles flow; a fluid supply unit that supplies a fluid to the flow path; a sample introduction unit that introduces the sample into the flow path; a laser irradiation device that irradiates the flow path with a plurality of laser beams; and a control device that controls irradiation conditions of the plurality of laser beams.

### Effects of the Inventions

According to the present disclosure, in field-flow fractionation, the recovery rate of particles can be improved.

### BRIEF DESCRIPTION OF THE DRAWINGS

FIG. 1 is a schematic diagram showing a configuration of a field-flow fractionation device in the present embodiment.

FIG. 2 is a functional block diagram of a control device in the present embodiment.

FIG. 3 is a schematic diagram showing a configuration of a field-flow fractionation device in a comparative example.

FIG. 4 is a diagram for explaining a method for classifying particles in the comparative example.

FIG. 5 is a diagram for explaining a method for classifying particles in the present embodiment.

FIG. 6 is a flowchart for explaining a method for classifying particles in the present embodiment.

FIG. 7 is a flowchart showing a subroutine of step S10 shown in FIG. 6.

### MODE FOR CARRYING OUT THE INVENTION

Hereinafter, embodiments of the present disclosure will be described in detail with reference to the drawings. Note that the same or corresponding parts in the drawings are denoted by the same reference numerals, and the description thereof will not be repeated.

### Device Configuration

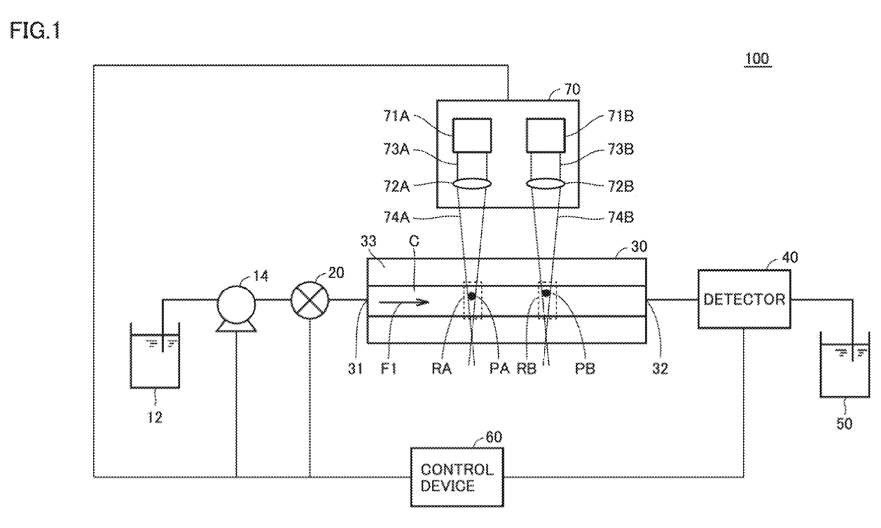

The configuration of an FFF device in the present embodiment will be described. FIG. 1 is a schematic diagram for explaining a configuration of an FFF device 100 in the embodiment. The FFF device 100 classifies particles in a sample. In the present disclosure, classifying particles means dividing a sample containing particles of a plurality of types of diameters into a plurality of particle groups based on the size of the particles. For example, classifying particles means dividing a sample containing first particles of a first diameter and second particles of a second diameter smaller than the first diameter into a particle group containing the first particles and a particle group containing the second particles. The type of particles to be classified is not particularly limited, but it is preferable that the particles do not change their shape or properties due to laser beam irradiation and heat generated by the laser beam irradiation. The diameter of the particles to be classified is a diameter of particles that can be captured by a trapping force generated by a laser beam, and is, for example, 0.1nm to 100 micrometers.

Referring to FIG. 1, the FFF device 100 includes a container 12, a liquid delivery pump 14, a sample introduction unit 20, a flow cell 30, a detector 40, a waste liquid container 50, a control device 60, and a laser irradiation device 70.

The container 12 stores a fluid for eluting particles. The fluid is, for example, water, an aqueous solution, and an organic solvent (for example, THF and toluene).

The liquid delivery pump 14 delivers the fluid stored in the container 12 to the flow cell 30. In the present embodiment, the container 12 and the liquid delivery pump 14 are an example of a fluid supply unit that supplies a fluid to the flow cell 30.

The sample introduction unit 20 introduces a sample to be separated into the FFF device 100. The sample introduction unit 20 is provided in the middle of a flow path connecting the liquid delivery pump 14 and the flow cell 30. The sample introduced into the flow path is introduced into the flow cell 30 together with the fluid delivered from the liquid delivery pump 14. The sample introduction unit 20 introduces the sample by, for example, pressurized liquid delivery or a syringe pump.

The flow cell 30 constitutes a flow path through which particles in the sample flow. The flow cell 30 includes an inlet port 31, an outlet port 32, and a housing 33. Inside the flow cell 30, a separation channel C, which is a flow path through which the fluid and the particles in the sample flow, is formed. Although the shape of the separation channel C is not particularly limited, it is, for example, a cylindrical shape. An inlet port 31 and an outlet port 32 are provided at ends of the separation channel C. The inlet port 31 is connected to the liquid delivery pump 14, and the outlet port 32 is connected to the detector 40. The fluid is supplied from the inlet port 31 to the separation channel C. Further, the fluid that has reached the outlet port 32 goes toward the detector 40. Therefore, a fluid flow F1 from the inlet port 31 toward the outlet port 32 is formed in the separation channel C. In the present embodiment, the separation channel C corresponds to a flow path through which particles in the sample flow.

The housing 33 is provided with holes for providing the inlet port 31 and the outlet port 32. A cavity formed inside the housing 33 corresponds to the separation channel C. In the housing 33, at least a region through which the laser beam irradiated by the laser irradiation device 70 passes need to be transparent, but other parts do not have to transmit light. The laser irradiation device 70 irradiates the housing 33 with a plurality of laser beams. Therefore, the housing 33 is preferably made of a material that is not deformed by the laser beams and heat generated accompanying the irradiation of the laser beams.

The laser irradiation device 70 irradiates the separation channel C of the flow cell 30 with a plurality of laser beams including laser beams 74A and 74B. The laser irradiation device 70 includes a plurality of light sources and a plurality of lenses that concentrate laser beams output from the respective light sources. In FIG. 1, the laser beams 74A and 74B are shown as examples among the plurality of laser beams, but the laser irradiation device 70 can irradiate laser beams other than the laser beams 74A and 74B, and although not shown in FIG. 1, includes light sources and lenses for irradiating laser beams other than the laser beams 74A and 74B. Note that the laser beam is preferably irradiated from a direction perpendicular to the flow F1 of the separation channel C, but is not particularly limited.

Each of the plurality of light sources outputs a laser beam toward a lens corresponding to each light source. For example, the light source 71A outputs a laser beam 73A toward the lens 72A, and the light source 71B outputs a laser beam 73B toward the lens 72B.

The laser beams that have passed through the lenses are concentrated in focusing regions corresponding to the respective laser beams. The focusing regions are located in the flow path C of the separation channel. For example, the laser beam 74A that has passed through the lens 72A is concentrated in the focusing region RA of the separation channel C, and the laser beam 74B that has passed through the lens 72B is concentrated in the focusing region RB of the separation channel C. The diameter of the laser beam in the focusing region corresponds to the spot diameter of the laser beam.

Each of the plurality of laser beams irradiated from the laser irradiation device 70 to the flow path C captures particles by the effect of optical tweezers. For example, the laser beams 74A and 74B capture particles PA and PB in the focusing regions RA and RB, respectively, by the effect of optical tweezers. According to the effect of optical tweezers, particles can be kept in the focusing region of the laser beam by transmission of momentum due to photon scattering. Optical tweezers are also called optical manipulation or optical traps.

The detector 40 detects particles introduced into the FFF device 100 and acquires measurement data. The type of the detector 40 is not limited, and the type can be selected according to an analysis method desired by a user. The detector 40 is, for example, an ultraviolet detector, a fluorescence detector, a refractive index detector, a dynamic light scattering detector, a multi-angle light scattering detector, and a conductivity detector. The measurement data includes, for example, the elapsed time from the time point when the sample was introduced into the FFF device 100 and the signal intensity detected by the detector 40. The signal intensity reflects, for example, the number of particles. Note that when a detector 40 capable of detecting particles satisfying a predetermined condition is used, the signal intensity reflects the number of particles satisfying the predetermined condition. For example, when a fluorescence detector is used as the detector 40, the signal intensity reflects the number of particles that emit fluorescence.

In the waste liquid container 50, particles and fluid that have passed through the detector 40 are stored. Note that in order to recover particles after passing through the detector 40, the FFF device 100 may include a recovery device (for example, a fraction collector) that recovers the particles and liquid that have passed through the detector 40, instead of the waste liquid container 50.

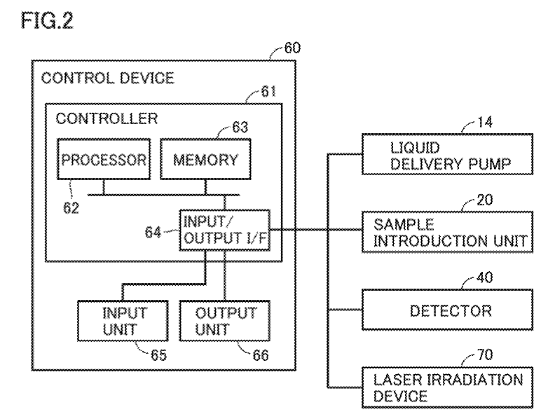

FIG. 2 is a functional block diagram of the control device 60. Referring to FIG. 2, the control device 60 includes a controller 61, an input unit 65, and an output unit 66. An input unit 65 and an output unit 66 are connected to the controller 61. The control device 60 controls the FFF device 100, analyzes measurement data obtained by the detector 40, and generates an analysis result showing a diameter distribution and the like. The control device 60 is, for example, a computer. Note that the control device 60 does not need to be configured by one computer and may be configured by a plurality of computers.

The controller 61 includes a processor 62, a memory 63, and an input/output interface (I/F) 64 as main components. These units are communicably connected to each other via a bus.

The processor 62 is an example of an electric circuit, and by executing a given program, analyzes the measurement data acquired by the detector 40 and generates an analysis result. The analysis result includes the number of types of detected particle diameters and a frequency distribution of particles in the sample based on the particle diameters. The program executed by the processor 62 may be stored in the memory 63 or may be stored in a storage device outside the control device 60. The processor 62 is, for example, a CPU (Central Processing Unit). Note that the processor 62 may be implemented as hardware, software, or a combination thereof.

The memory 63 can store a program executed by the processor 62, measurement data, and an analysis result. The memory 63 includes volatile memory (for example, RAM (Random Access Memory)) and non-volatile memory (for example, ROM (Read Only Memory), a hard disk drive, and/or a solid-state drive).

The input/output I/F 64 is an interface for exchanging various types of data between the processor 62 and the liquid delivery pump 14, the sample introduction unit 20, the detector 40, and the laser irradiation device 70 which are connected to the input/output I/F 64. The control device 60 controls the flow rate of the flow F1 by controlling the liquid delivery pump 14. Further, the control device 60 controls the timing at which the sample introduction unit 20 introduces the sample and the flow rate at which the sample is introduced. Furthermore, the control device 60 controls irradiation conditions of a plurality of laser beams by the laser irradiation device 70. The irradiation conditions include the intensity of the laser beam, the wavelength of the laser beam, and the spot diameter of the laser beam. The spot diameter is the diameter of the laser beam in the focusing region. Note that one irradiation condition is set for a plurality of laser beams, and each of the plurality of laser beams is irradiated under the same irradiation condition.

The input unit 65 receives input of information to the controller 61. The information is, for example, a flow rate of a fluid delivered by the liquid delivery pump 14, an amount of sample introduced by the sample introduction unit 20, a timing at which the sample introduction unit 20 introduces the sample, and irradiation conditions. The input unit 65 is configured by, for example, a touch panel, a mouse, and a keyboard.

The output unit 66 displays information in accordance with instructions from the controller 61. The information is, for example, measurement data and analysis results. The output unit 66 is configured by, for example, a liquid crystal display capable of displaying an image.

### Comparative Example

As one of the methods for classifying fine particles in a solution, the AF4 method, which is a cross-flow particle classification method adopting an asymmetrical channel structure, is known. The AF4 method forms a separation field by the flow of fluid and classifies particles in a sample according to their size.

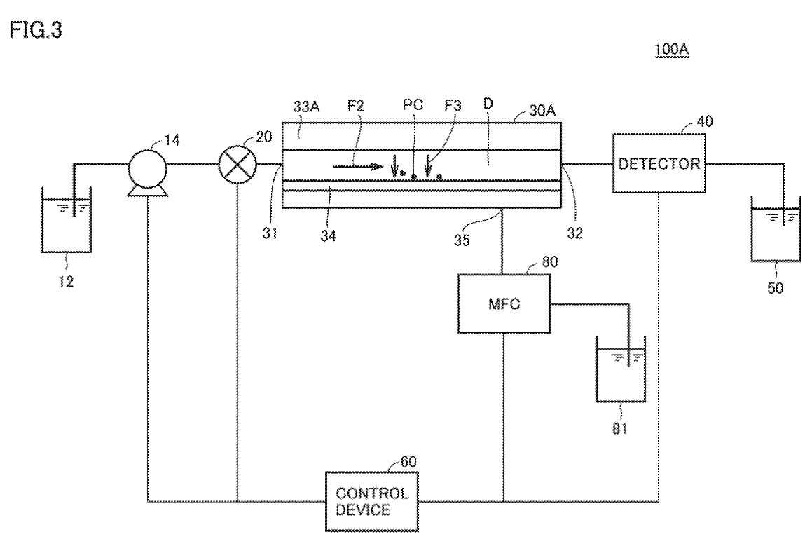

FIG. 3 is a diagram for explaining an FFF device 100A in a comparative example. The FFF device 100A shown in FIG. 3 includes a container 12, a liquid delivery pump 14, a sample introduction unit 20, a flow cell 30A, a detector 40, a waste liquid container 50, a control device 60, and an MFC 80. Compared with the FFF device 100 shown in FIG. 1, it differs in that it does not include the laser irradiation device 70. Note that components that are the same as or substantially the same as those of the FFF device 100 shown in FIG. 1 are denoted by the same reference numerals, and redundant description will be omitted.

The flow cell 30A includes an inlet port 31, an outlet port 32, a housing 33A, a separation membrane 34, and a discharge port 35. Inside the flow cell 30A, a separation channel D, through which the fluid and particles PC in the sample flow, is formed. An inlet port 31 and an outlet port 32 are provided at ends of the separation channel D. The fluid is supplied from the inlet port 31 to the separation channel D, reaches the outlet port 32, and then goes toward the detector 40.

The separation channel D is formed so that a fluid flow F2 introduced from the inlet port 31 and directed toward the outlet port 32 is a laminar flow, which is a layered flow. In the flow F2, the closer to the center of the separation channel D, the faster the flow. The flow F2 is called a "channel flow."

One wall surface parallel to the flow F2 in the separation channel D is configured by a separation membrane 34 having a property of transmitting fluid but not transmitting particles in the sample. Since part of the fluid introduced into the separation channel D passes through the separation membrane 34, a flow F3 orthogonal to the flow F2 is generated in the separation channel D. The flow F3 is called a "cross flow."

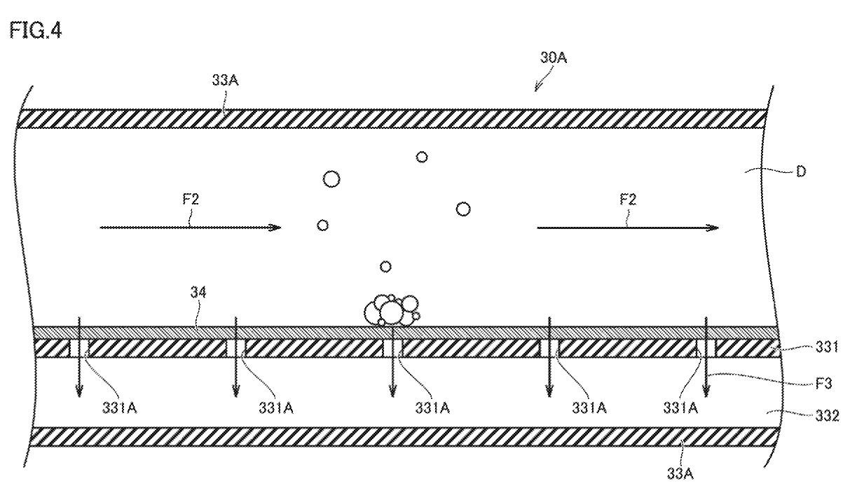

The fluid that has passed through the separation membrane 34 passes through a filter of the housing 33A, flows through a flow path in the housing 33A, and is discharged to the outside from the discharge port 35. A multi flow controller (MFC) 80 is provided on the flow path connected to the discharge port 35, and the flow rate of the fluid discharged from the flow path in the housing 33 is detected by the MFC 80. Note that the filter of the housing 33A and the flow path in the housing 33A will be described in FIG. 4.

The MFC 80 adjusts the flow rate of the fluid discharged from the discharge port 35. Thereby, the flow rate of the fluid passing through the separation membrane 34 changes. Therefore, the MFC 80 can adjust the flow rate of the flow F3 by adjusting the flow rate of the fluid discharged from the discharge port 35. The fluid that has passed through the MFC 80 is drained to a waste liquid container 81.

FIG. 4 is a diagram for explaining a particle classification method using the FFF device 100A in the comparative example. FIG. 4 shows a cross section parallel to the flow F2 and the flow F3 in the separation channel D.

Referring to FIG. 4, the FFF device 100A according to the comparative example generates a flow F2 and a flow F3 orthogonal to the flow F2 to form a separation field. The flow F3 is formed when the fluid that has passed through the separation membrane 34 passes through holes 331A of a filter 331 of the housing 33A and flows through a flow path 332 in the housing 33.

The particles in the sample introduced from the sample introduction unit 20 are pressed against the separation membrane 34 by the flow F3. Thereafter, when the flow rate of the flow F3 is decreased by the MFC 80, the particles pressed against the separation membrane 34 diffuse in a direction opposite to the direction of the flow F3, which is a direction in which the concentration is lower. Nano-to-submicron sized particles are known to have a diffusion coefficient dependent on size. That is, particles with smaller diameters have larger diffusion coefficients. Therefore, particles with smaller diameters diffuse over a wider range. In the separation channel D, particles with smaller diameters reach positions further away from the separation membrane 34, and as the diameter increases, the particles stay near the separation membrane 34 without diffusing.

Thereafter, fluid is caused to flow toward the outlet port 32 in the separation channel D, whereby the diffused particles are introduced into the detector 40. In the separation channel D, the flow F2 of the fluid from the inlet port 31 toward the outlet port 32 is a laminar flow, so the flow velocity is faster in a layer closer to the center of the separation channel D. Therefore, particles with smaller diameters that have diffused to near the center of the separation channel D are introduced into the detector 40 in order.

As described above, according to the FFF device 100A according to the comparative example, particles in a sample can be classified based on the size of the diameter. However, the particle classification method using the FFF device 100A according to the comparative example includes a step of pressing particles against the separation membrane 34 by the flow F3. Some particles pressed against the separation membrane 34 are adsorbed to the separation membrane 34. The adsorbed particles may not be eluted from the flow cell 30A even by the flow F2. In such a case, the adsorbed particles cannot be detected by the detector 40, so the recovery rate of particles decreases.

### Field-Flow Fractionation Device in Embodiment

Therefore, the FFF device 100 in the present embodiment includes a laser irradiation device 70 that irradiates the separation channel C with a plurality of laser beams for classifying particles. Thereby, the FFF device 100 can classify particles without pressing the particles against a separation membrane. Therefore, particles can be prevented from being adsorbed to a separation membrane. According to the FFF device 100, the particles introduced into the separation channel C are eluted without being adsorbed to a separation membrane, so the recovery rate of particles can be improved.

### Particle Classification Method

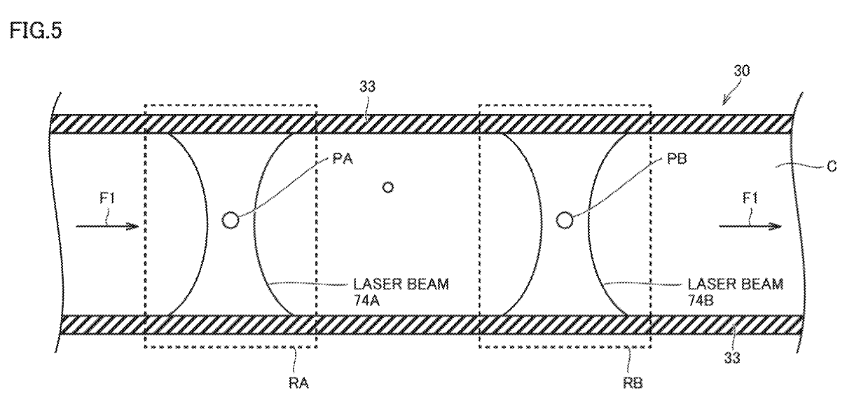

A particle classification method using the FFF device 100 will be described. FIG. 5 is a diagram for explaining a particle classification method by the FFF device 100. FIG. 5 corresponds to a cross-sectional view along the flow F2 in the separation channel C.

The laser irradiation device 70 irradiates the separation channel C with a plurality of laser beams including laser beams 74A and 74B at a first intensity. Each of the plurality of irradiated laser beams is concentrated in a corresponding focusing region. For example, the laser beams 74A and 74B are concentrated in the focusing regions RA and RB of the separation channel C, respectively. Each of the particles included in the sample introduced from the sample introduction unit 20 to the separation channel C is caused to flow from the inlet port 31 toward the focusing regions including the focusing regions RA and RB by the flow F1. Particles larger than the diameter of particles that can be captured by the laser beam of the first intensity stay in the focusing region.

The higher the intensity of the irradiated laser beam, the smaller the diameter of particles that can be captured. Specifically, as the laser intensity of the laser beam increases, the lower limit of the diameter of particles that can be captured by each of the plurality of laser beams decreases. As the intensity of the laser beam decreases, the trapping force generated by the laser beam decreases, and the lower limit of the diameter of particles that can be captured by each of the plurality of laser beams increases.

By increasing the intensity of the laser beam, the lower limit of the diameter of particles that can be captured decreases, but there is a limit to the minimum value of the diameter of particles that can be captured by the laser beam. The minimum value of the diameter of particles that can be captured by each of the plurality of laser beams is, for example, about 0.1nm.

Further, when the laser irradiation device 70 irradiates the laser beam at the first intensity, the laser beam can capture particles larger than the diameter of particles that can be captured by the laser beam of the first intensity, but there is a limit to the maximum value of the diameter that can be captured. The maximum value of the diameter of particles that can be captured by each of the plurality of laser beams is, for example, about 100 micrometers.

For example, in a case where the smallest diameter that can be captured by the laser beam of the first intensity is a third diameter, when a plurality of laser beams are irradiated at the first intensity and a sample is introduced, particles having a diameter equal to or larger than the third diameter can be captured. Particles having a diameter smaller than the third diameter are eluted from the flow cell 30 by the flow F1.

Here, when the intensity of the laser beam is decreased from the first intensity, the trapping force of the laser beam weakens. Since a particle with a smaller diameter requires a larger trapping force for capture, when the intensity of the laser beam is decreased, particles are released from the focusing region in order from those with a larger diameter. The particles released from the focusing region are eluted from the flow cell 30 by the flow F1. Thereby, the particles can be classified.

The particles eluted from the flow cell 30 are introduced into the detector 40. Particles are introduced into the detector 40 in order from those with a smaller diameter. The measurement data generated by the detector 40 includes, for example, the elapsed time from the time point when the sample was introduced and the signal intensity detected by the detector 40. The signal intensity reflects the number and concentration of particles. Since the particles are introduced in order from those with a smaller diameter, the diameter of the particles detected by the detector 40 increases according to the elapsed time from the time point when the sample was introduced. For example, the measurement data is output with the elapsed time from the time point when the sample was introduced as the horizontal axis and the signal intensity at that time as the vertical axis. By checking the output measurement data, the user can recognize the types of diameters of particles in the sample and the quantity of particles of each diameter.

Note that the intensity of the laser beam is expressed, for example, by light intensity (W). The intensity of the laser beam is, for example, 1mW to 100mW.

The intensity of the laser beam may decrease continuously or step-by-step. For example, when the maximum value of the laser beam intensity is 20 mW, the laser beam intensity decreases from 20mW to 0mW in a first time period. The first time period is, for example, 5 minutes. Further, when the maximum value of the laser beam intensity is 20mW, the laser beam intensity may decrease by 5mW every second time period, such as 20mW → 15mW → 10mW → 5mW → 0mW. The second time period is, for example, 30 seconds.

The sample introduction unit 20 may introduce the sample into the flow cell 30 before the laser beam is irradiated, but it is preferable that the sample introduction unit 20 introduces the sample in a state where the laser beam is irradiated. If the sample introduction unit 20 introduces the sample into the flow cell 30 before the laser beam is irradiated, particles that have passed through the focusing region before the laser beam is irradiated are eluted from the flow cell 30 without being classified by the laser beam. Therefore, by the sample introduction unit 20 introducing the sample in the state where the laser beam is irradiated, the number of particles eluted from the flow cell without being held by the laser beam can be reduced as compared with the case where the sample introduction unit 20 introduces the sample into the flow cell 30 before the laser beam is irradiated.

The spot diameter of the laser beam in the focusing region is preferably larger than the width (diameter) of the separation channel C. By doing so, it is possible to prevent particles that have flowed in from the inlet port 31 in the separation channel C from being eluted from the outlet port 32 without passing through the focusing region of the laser beam. Particles that do not pass through the focusing region cannot be classified because the laser beam cannot capture them. The irradiation conditions of the laser beam include the spot diameter of the laser beam, and the control device 60 can change the spot diameter of the laser beam by controlling the laser irradiation device 70.

### Determination of Laser Beam Irradiation Conditions

In the FFF device 100 according to the present disclosure, the range of particle diameters captured by the laser beam differs depending on the irradiation conditions of the laser beam. The irradiation conditions of the laser beam include the intensity of the laser beam. The irradiation conditions of the laser beam may be predetermined or may be determined by the user according to the sample.

For example, when the user knows the range of particle diameters included in the sample, or when the range of particle diameters captured by the laser beam is clear, the user determines the laser beam irradiation conditions so that particles in the target diameter range can be captured.

In addition, for example, when the range of particle diameters included in the sample is unknown, the control device 60 determines the irradiation conditions of the laser beam based on the analysis result obtained by subjecting a part of the sample to the FFF device 100. Specifically, first, a sample to be analyzed is divided into three: a first study sample, a second study sample, and an analysis sample. The first study sample is subjected to the FFF device 100, and first measurement data obtained by classifying a first particle group included in the first study sample is acquired. At that time, a second intensity is used as the laser irradiation condition. This irradiation condition is set as a first condition. Subsequently, a second study sample is subjected to the FFF device 100 using a third intensity different from the second intensity as the laser irradiation condition, and second measurement data obtained by classifying a second particle group included in the second study sample is acquired. This irradiation condition is set as a second condition. The first analysis result generated from the first measurement data and the second analysis result generated from the first measurement data are compared, and the irradiation condition of the analysis sample is determined. At this time, a laser irradiation condition with high classification accuracy is determined as the irradiation condition of the analysis sample. High classification accuracy means, for example, that the number of types of particle diameters shown in the analysis result is large. Specifically, if the first analysis result shows that the sample contains particles with a diameter of 1 micrometer and particles with a diameter of 5 micrometers, and the second analysis result shows that the sample contains particles with a diameter of 3 micrometers in addition to particles with a diameter of 1 micrometer and particles with a diameter of 5 micrometers, the number of types of particle diameters shown in the first analysis result is "2", and the number of types of particle diameters shown in the second analysis result is "3". Therefore, it can be said that the laser irradiation condition under which the second measurement data was obtained has higher classification accuracy. Therefore, the control device 60 determines the first condition as the irradiation condition of the laser beam for classifying the analysis sample.

### Flow of Particle Classification Method

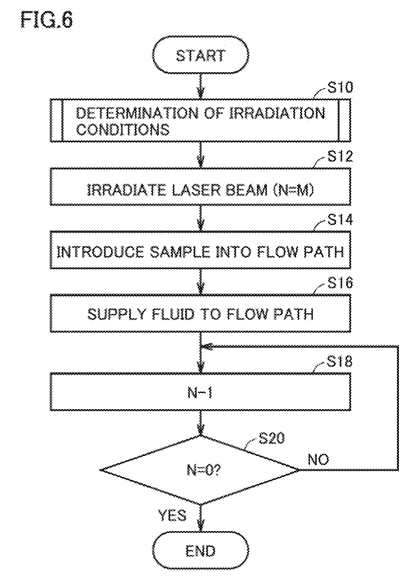

A particle classification method in the present embodiment will be described. FIG. 6 is a flowchart for explaining a method for classifying particles using the FFF device 100 according to the present disclosure. The processing of FIG. 6 is started, for example, in response to an instruction to classify particles in an application program executed in the control device 60. Note that in one implementation example, the processing of FIG. 6 is performed in a state where a sample to be classified is placed in the sample introduction unit 20. The contents of the processing will be described with reference to FIG. 6.

In step S10, the control device 60 determines irradiation conditions of a laser beam to be irradiated from the laser irradiation device 70. The irradiation conditions of the laser beam may be predetermined or may be determined by the user. The irradiation conditions of the laser beam include the intensity of the laser beam, the wavelength of the laser beam, and the spot diameter of the laser beam.

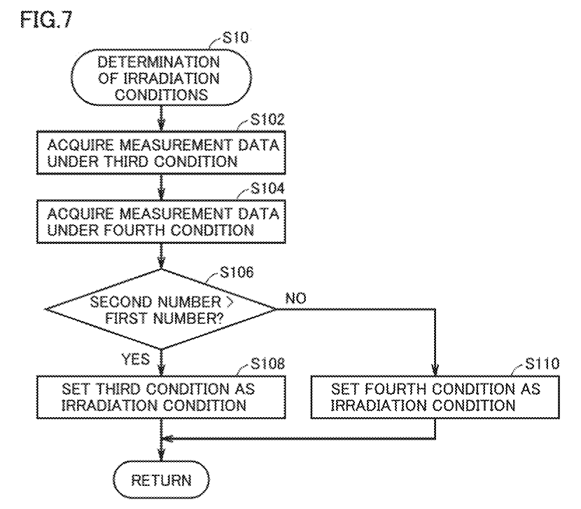

FIG. 7 is a flowchart of a laser beam irradiation condition determination processing subroutine of step S10. Processing for determining the irradiation conditions of the laser beam will be described with reference to FIG. 7.

Referring to FIG. 7, in step S102, the control device 60 supplies a part of the sample to be analyzed to the FFF device 100 and acquires measurement data under a third condition.

In step S104, the control device 60 supplies a part of the sample to be analyzed to the FFF device 100 and acquires measurement data under a fourth condition.

In step S106, the control device 60 determines whether a second number, which is the type of particle diameter in the analysis result generated from the measurement data of the third condition, is larger than a first number, which is the type of particle diameter in the analysis result generated from the measurement data of the fourth condition. When it is determined that the second number is larger than the first number (YES in step S106), the control device 60 proceeds to step S108, and otherwise (NO in step S106), the control device 60 proceeds to step S110.

In step S108, the control device 60 determines the second condition as the irradiation condition. Thereafter, the control device 60 ends the processing for determining the irradiation conditions of the laser beam, and returns the processing to FIG. 6.

In step S110, the control device 60 determines the first condition as the irradiation condition. Thereafter, the control device 60 ends the processing for determining the irradiation conditions of the laser beam, and returns the processing to FIG. 6.

Returning to FIG. 6, in step S12, the control device 60 irradiates the separation channel C of the flow cell 30 with a plurality of laser beams according to the irradiation condition determined in step S10. At this time, the intensity of the laser beam is set to M, which is the maximum value among M stages, and the value of a variable N used in the processing of FIG. 6 is set to M. Each of the plurality of irradiated laser beams is concentrated in a corresponding focusing region.

In step S14, the control device 60 introduces a sample into the flow path of the FFF device 100 by the sample introduction unit 20.

In step S16, the control device 60 supplies the fluid stored in the container 12 to the flow path at a predetermined flow rate by the liquid delivery pump 14. The supplied fluid flows into the separation channel C from the inlet port 31 of the flow cell 30 and is discharged from the outlet port 32.

Here, the particles introduced into the separation channel C by the supplied fluid are caused to flow toward the outlet port 32 and are captured in each of the plurality of focusing regions.

In step S18, the control device 60 subtracts 1 from the variable N. Thereby, the intensity of the laser beam decreases by one step.

In step S20, the control device 60 determines whether the variable N is 0. When it is determined that the variable N is 0 (YES in step S20), the control device 60 ends the processing of FIG. 6, and otherwise (NO in step S20), returns the processing to step S18. In one implementation example, step S18 is performed every fixed time (for example, the "second time period" described above). Thus, in the example of FIG. 6, the intensity of the laser beam decreases step-by-step at regular time intervals.

In the present embodiment, it has been described that the intensity of the laser beam is decreased in order to elute particles with smaller diameters, but the present invention is not limited thereto. For example, in order to elute particles with smaller diameters, the amount of liquid delivery per unit time by the liquid delivery pump 14 may be increased. Thereby, the force causing the particles to flow toward the outlet port 32 by the flow F1 increases, so that the particles are eluted from the flow cell 30 in order from those with a smaller diameter, which requires a larger force to be captured in the focusing region.

Note that, in the above-described embodiment, an example in which the laser irradiation device 70 includes a plurality of light sources that output laser beams has been described, but the present invention is not limited thereto. The laser irradiation device may include one light source and an optical element for splitting the laser beam output from the light source. The optical element is, for example, a beam splitter. The beam splitter includes a diffraction beam splitter. By using the optical element, the laser irradiation device 70 can split a laser beam output from one light source and irradiate the flow cell with a plurality of laser beams.

The laser irradiation device may include a plurality of light sources and a plurality of optical elements that split laser beams. By the plurality of optical elements splitting the laser beams output from the plurality of light sources, more laser beams can be irradiated onto the flow cell. Note that since one particle is captured per laser beam irradiated onto the flow cell, the recovery rate of particle classification can be improved by irradiating many laser beams onto the flow cell.

According to the field-flow fractionation device related to the present disclosure, particles can be classified without using a separation membrane. Therefore, it is possible to prevent a decrease in the particle recovery rate due to particles being adsorbed to a separation membrane, so the particle recovery rate can be improved.

### Aspects

It will be understood by those skilled in the art that the plurality of exemplary embodiments described above are specific examples of the following aspects.

(Item 1) A field-flow fractionation device in one aspect is a field-flow fractionation device for classifying particles included in a sample, and may include: a flow cell constituting a flow path through which the particles flow; a fluid supply unit that supplies a fluid to the flow path; a sample introduction unit that introduces the sample into the flow path; a laser irradiation device that irradiates the flow path with a plurality of laser beams; and a control device that controls irradiation conditions of the plurality of laser beams.

According to the field-flow fractionation device described in Item 1, the recovery rate of particles can be improved in field-flow fractionation.

(Item 2) In the field-flow fractionation device according to Item 1, the control device may further control the fluid supply unit and the sample introduction unit.

According to the field-flow fractionation device described in Item 2, the control device can control not only the light source that irradiates the laser beam, but also the fluid supply unit that supplies the fluid and the sample introduction unit that introduces the sample.

(Item 3) In the field-flow fractionation device according to Item 2, the irradiation conditions include the intensity of the laser beam, and the control device may control the fluid supply unit to supply the fluid to the flow path while weakening the intensity of the laser beam after controlling the intensity of the laser beam to a first intensity.

According to the field-flow fractionation device described in Item 3, after the particles are held in the flow cell by the laser beam of the first intensity, the intensity of the laser beam is decreased. Among the particles that had been captured, particles with smaller diameters become less likely to be captured by the laser beam. Here, by the fluid being supplied to the flow path in the flow cell, particles are eluted from the flow cell in order from those with a smaller diameter. Therefore, the particles can be classified according to the diameter.

(Item 4) In the field-flow fractionation device according to Item 2 or 3, the control device may control the sample introduction unit to introduce the sample into the flow path in a state where the laser irradiation device is caused to irradiate the flow path with the plurality of laser beams.

According to the field-flow fractionation device described in Item 4, the sample is introduced into the flow cell in the state where the flow cell is irradiated with the laser beam. Therefore, particles can be prevented from passing through the flow cell in a state where the flow cell is not irradiated with the laser beam.

(Item 5) The field-flow fractionation device according to any one of Items 1 to 4 further includes a detector that analyzes the particles that have passed through the flow path, and the control device may determine the irradiation conditions based on measurement data acquired by the detector.

According to the field-flow fractionation device described in Item 5, laser beam irradiation conditions can be determined based on the measurement data acquired by the detector.

(Item 6) In the field-flow fractionation device according to Item 5, the measurement data may include the number of types of diameters of the particles.

According to the field-flow fractionation device described in Item 6, the laser beam irradiation conditions can be determined based on the number of types of particle diameters in the measurement data.

(Item 7) In the field-flow fractionation device according to Item 6, the control device may determine the second condition as the irradiation condition when the measurement data of the first condition includes a first number of types of diameters of the particles and the measurement data of the second condition includes a second number of types of diameters of the particles, the second number being greater than the first number.

According to the field-flow fractionation device described in Item 7, a condition under which the types of diameters of particles become more numerous can be determined as the laser beam irradiation condition.

(Item 8) In the field-flow fractionation device according to any one of Items 1 to 7, the irradiation conditions include a spot diameter of the laser beam in a predetermined region of the flow path, and the spot diameter of the laser beam may be larger than the width of the flow path.

According to the field-flow fractionation device described in Item 8, the diameter of the spot where the laser beam is concentrated is larger than the width of the flow path through which the particles flow. Thereby, particles flowing through the flow path pass through a region where the laser beam is concentrated. Therefore, in the case where the diameter of the spot where the laser beam is concentrated is larger than the width of the flow path through which the particles flow, the ratio of particles captured by the laser beam can be increased as compared with the case where the diameter of the spot where the laser beam is concentrated is smaller than the width of the flow path through which the particles flow.

(Item 9) In the field-flow fractionation device according to any one of Items 1 to 8, the laser irradiation device may include a first light source that outputs a first laser beam, a second light source that outputs a second laser beam, a first lens that focuses the first laser beam in a first region of the flow path, and a second lens that focuses the second laser beam in a second region of the flow path.

According to the field-flow fractionation device described in Item 9, the laser beam output from the first light source is focused in the first region by the first lens, and the laser beam output from the second light source is focused in the second region by the second lens. Thereby, particles can be captured in each of the first region and the second region.

(Item 10) In the field-flow fractionation device according to any one of Items 1 to 9, the laser irradiation device may include a third light source that outputs a third laser beam and an optical element that splits the third laser beam.

According to the field-flow fractionation device described in Item 10, the laser beam output from the third light source is split and irradiated onto the flow cell. Therefore, the number of laser beams to be irradiated can be increased more than the number of light sources. By increasing the number of laser beams to be irradiated, the classification accuracy can be improved.

(Item 11) In the field-flow fractionation device according to Item 10, the optical element may be a beam splitter.

According to the field-flow fractionation device described in Item 11, the laser beam output from the third light source can be split by the beam splitter.

The embodiments disclosed this time should be considered as illustrative and not restrictive in all respects. The scope of the present disclosure is indicated not by the above description of the embodiments but by the claims, and is intended to include all modifications within the meaning and scope equivalent to the claims. Further, it is intended that each technique in the embodiments can be implemented alone or in combination with other techniques in the embodiments as much as possible as needed.

### DESCRIPTION OF REFERENCE NUMERALS

12 container, 14 liquid delivery pump, 20 sample introduction unit, 30, 30A flow cell, 31 inlet port, 32 outlet port, 33, 33A housing, 34 separation membrane, 35 discharge port, 40 detector, 50, 81 waste liquid container, 60 control device, 61 controller, 62 processor, 63 memory, 64 input/output I/F, 65 input unit, 66 output unit, 70 laser irradiation device, 71A, 71B light source, 72A, 72B lens, 100, 100A field-flow fractionation device.

1. A field-flow fractionation device for classifying particles included in a sample, comprising:
a flow cell constituting a flow path through which the particles flow;
a fluid supply unit that supplies a fluid to the flow path;
a sample introduction unit that introduces the sample into the flow path;
a laser irradiation device that irradiates the flow path with a plurality of laser beams; and
a control device that controls irradiation conditions of the plurality of laser beams.

2. The field-flow fractionation device according to claim 1, wherein the control device further controls the fluid supply unit and the sample introduction unit.

3. The field-flow fractionation device according to claim 2, wherein
the irradiation conditions include the intensity of the laser beam, and
the control device controls the fluid supply unit to supply the fluid to the flow path while weakening the intensity of the laser beam after controlling the intensity of the laser beam to a first intensity.

4. The field-flow fractionation device according to claim 2, wherein the control device controls the sample introduction unit to introduce the sample into the flow path in a state where the laser irradiation device is caused to irradiate the flow path with the plurality of laser beams.

5. The field-flow fractionation device according to claim 1, further comprising a detector that analyzes the particles that have passed through the flow path,
wherein the control device determines the irradiation conditions based on measurement data acquired by the detector.

6. The field-flow fractionation device according to claim 5, wherein the measurement data includes the number of types of diameters of the particles.

7. The field-flow fractionation device according to claim 6, wherein the control device determines the second condition as the irradiation condition when the measurement data of the first condition includes a first number of types of diameters of the particles and the measurement data of the second condition includes a second number of types of diameters of the particles, the second number being greater than the first number.

8. The field-flow fractionation device according to claim 1, wherein
the irradiation conditions include a spot diameter of the laser beam in a predetermined region of the flow path, and
the spot diameter of the laser beam is larger than the width of the flow path.

9. The field-flow fractionation device according to claim 1, wherein the laser irradiation device includes:
a first light source that outputs a first laser beam;
a second light source that outputs a second laser beam;
a first lens that focuses the first laser beam in a first region of the flow path; and
a second lens that focuses the second laser beam in a second region of the flow path.

10. The field-flow fractionation device according to claim 1, wherein the laser irradiation device includes a third light source that outputs a third laser beam and an optical element that splits the third laser beam.

11. The field-flow fractionation device according to claim 10, wherein the optical element is a beam splitter.
